(19) United States
(12) Patent Application Publication
(10) Pub. No.: US 2004/0098862 A1
(43) Pub. Date: May 27, 2004

(54) Razor system having razor sensors

(75) Inventor: Glennis J. Orloff, Woodbridge, CT (US)

Correspondence Address: Richard R. Michaud, McCormick, Paulding & Huber LLP, CityPlace II, 185 Asylum Street, Hartford, CT, 06103, US

(73) Assignee: Eveready Battery Company, Inc., Westlake, OH

(21) Appl. No.: 10/643,366

(22) Filed: Aug. 19, 2003

Related U.S. Application Data
(60) Provisional application No. 60/405,257, filed on Aug. 21, 2002.

(51) Int. Cl. B26B 21/00

(52) U.S. Cl. 30/41.7; 30/41.8

(57) ABSTRACT

A razor system includes a razor cartridge having a blade and a handle attached to the razor cartridge. A sensor is disposed in the razor system for generating a sensor signal indicative of parameters sensed during a shave. The sensor includes at least one of an electromagnetic induction sensor, an ultrasonic sensor, a hall effect sensor, a capacitive sensor, a charge transfer sensor, an electric field sensor, a photoelectric sensor, a magnetostrictive sensor and an angular rate sensor.

### CROSS REFERENCE TO RELATED APPLICATIONS

The present invention is related to U.S. Pat. No. 6,009,623 for “RAZOR WITH IN SITU SENSOR”, and is also entitled to the benefit of and incorporates by reference essential subject matter disclosed in Provisional Patent Application No. 60/405,257 filed on Aug. 21, 2002.

### FIELD OF THE INVENTION

The present invention relates to sensors in razor systems. More specifically, the present invention relates to sensors in razor systems to monitor and respond to forces encountered during shaving to produce a movement of or indication on the shaving implement that aids in improving or evaluating the quality of the shave.

### BACKGROUND OF THE INVENTION

Efforts to improve shave quality have been on-going for many years. Much of the effort to improve shave quality has been directed toward making razor cartridges and blades more responsive to the various forces encountered by the razor during shaving. Examples of these efforts include razor systems having movable components, such as blades, cartridges which flex or bend in response to shaving forces and blades which move inward and outward in response to externally applied forces. In general, prior art shaving systems follow the contours of a user's skin as a result of external forces generated against the razor. Often this reaction occurs too late to avoid cutting or irritating a user's skin. This is due in large part to the fact that conventional razors do not anticipate a discontinuity. Rather the razor reacts to encountering one, making any compensation occur only after engaging the discontinuity.

Efforts have been made to incorporate piezoelectric, piezoresistive sensors, or potentiometers disposed in a non-directly skin-engaging position, within a razor system. During shaving, the sensor generates an electrical signal in response to externally applied forces relative to the razor cartridge and blades. The signals are transmitted to one or more receptors, which drives an actuator to adjust the system configuration or provides a detectable indication in response to the signals.

However, piezoelectric, piezoresistive, or potentiometer sensors can only generate signals in response to strain or movement of the sensors themselves and only indirectly detect movement or forces on the blades or razor cartridge. Additionally, piezoelectric/piezoresistive sensors and potentiometer sensors are not responsive to such factors as target (e.g., skin surface or blade surface) to sensor distance, density of the hirsute surface to be shaved, dynamic displacement measurements, and changes in capacitance between sensor and target. Moreover, the piezoelectric/piezoresistive sensors and potentiometer sensors can be affected by wear, dirt, dust or high moisture environments all of which are present during a shaving operation.

Based on the foregoing, it is the general object of the present invention to provide a razor system having sensors that overcomes or improves upon the problems and drawbacks associated with prior art razor systems.

### SUMMARY OF THE INVENTION

The present invention resides in one aspect in a razor system that includes a razor cartridge including at least one blade having an at least partially exposed cutting edge for cuffing hair present on a hirsute surface. A handle is attached to the razor cartridge. A non-piezoelectric sensor is coupled to the razor system for generating a sensor signal indicative of parameters sensed during a shaving operation.

In an embodiment of the invention, the razor system preferably includes a receptor electrically connected to the sensor. The receptor includes a signal conditioning circuit for processing a sensor signal and for generating a feedback signal in response thereto. The signal conditioning circuit may be electrically connected to an actuator which moves the blade or razor cartridge in response to the feedback signal. Alternatively the signal conditioning circuit may be electrically connected to an indicator which provides an indication, preferably in the form of a light, in response to the feedback signal.

In another embodiment of the invention, the actuator of the razor system may be operatively connected to the razor cartridge and move the razor cartridge in response to the feedback signal. Alternatively, the actuator may be operatively connected to a flexible section of the handle and move the flexible section in response to the feedback signal.

### BRIEF DESCRIPTION OF THE DRAWINGS

FIG. 1 is a top view of a razor cartridge having a capacitive sensor mounted thereon.

FIG. 2 is a cross-sectional view of the razor cartridge of FIG. 1 taken along line 2-2 showing the capacitive sensor.

FIG. 3 is a partially cross-sectional top view of a razor system including a handle and a razor cartridge having a sensor mounted to the handle.

FIG. 4 is a top view of a razor handle having an actuator adapted to receive signals from a sensor mounted to a razor cartridge.

FIG. 5 is a top view of a razor handle and cartridge having an actuator attached thereto and shown in a retracted position.

FIG. 6 is a top view of a razor handle and cartridge having an actuator in a neutral position.

FIG. 7 is a top view of a razor handle and cartridge having an actuator attached thereto and shown in an extended position.

FIG. 8 is a top view of a razor handle having a flexible section which is extendable or retractable by an actuator in the handle.

FIG. 9 is a top view of a razor handle having a flexible section shown in an angularly displaced position.

FIG. 10 is a top view of a razor handle having a flexible section rotatably positionable via an angular rate sensor disposed in the handle.

FIG. 11 is a top view of a razor handle having a razor cartridge mounted thereon showing an indicator light attached to the handle.

FIG. 12 is a top view of a razor system having electromagnetic induction sensors placed within the razor handle behind the razor cartridge.

FIG. 13 is a top view of a razor system having an ultrasonic sensor placed within the razor handle behind the razor cartridge.

FIG. 14 is a schematic diagram of a hall effect sensor for a razor system magnetic field is present.

FIG. 15 is a schematic diagram of a hall effect sensor for a razor system in the presence of a magnetic field.

FIG. 16 is a top view of a razor system having hall effect sensors placed within the razor handle behind the razor cartridge.

FIG. 17 is a schematic diagram of a charge transfer sensor for a razor system.

FIG. 18 is a side view of an exemplary electric field sensor disposed on a pair of parallel blades of a razor system.

FIG. 19 is a top view of a razor system having a photoelectric sensor placed within the razor handle behind the blade cartridge.

FIG. 20 is a partially cross sectional top view of a magnetostrictive sensor disposed against a blade of a razor system.

### DETAILED DESCRIPTION OF THE PREFERRED EMBODIMENTS

Reference will now be made to the presently preferred embodiments of the invention. Wet shave razors include both disposable razors, in which the user discards the entire unit after a certain number of uses, and permanent systems, wherein the user discards and replaces a blade carrying razor cartridge after a certain number of uses. The combination of the razor cartridge and the handle, either permanent or disposable, is defined herein as a razor system.

The present invention provides for a wet shave razor system having one or more sensors disposed therein which receive and produce a response to the externally applied forces encountered by a razor during shaving. As will be discussed in greater detail hereinafter, the sensors are preferably of the following types: electromagnetic induction, ultrasonic, hall effect, capacitive, charge transfer, electric field, photoelectric, magnetostrictive or angular rate.

The sensor may be placed in any desired location on the razor system. In addition, while the figures illustrate cartridges having two blades, the sensor may be utilized in a razor having more or less than two blades.

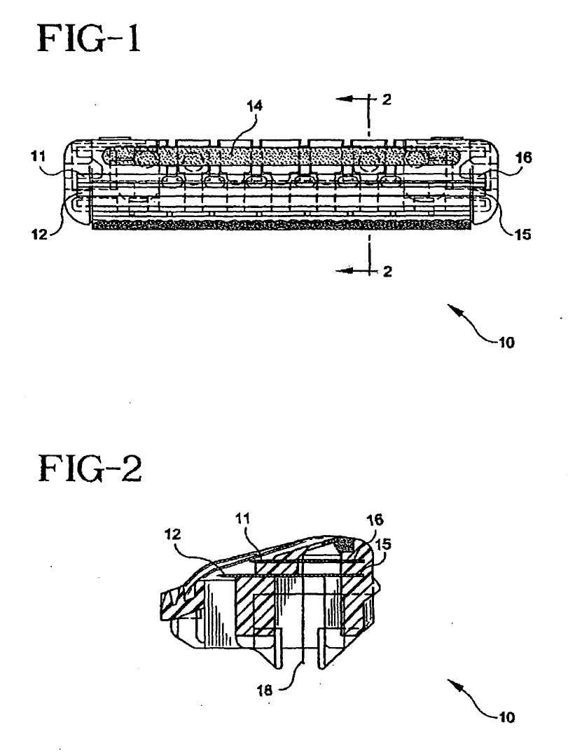

Referring to FIGS. 1 and 2, an exemplary embodiment of the invention is shown generally in a cartridge 10, which includes two blades, 11, 12, and a comfort strip 14. The pair of blades 11, 12 each have an outwardly facing, exposed cutting edge extending longitudinally of the cartridge 10. The comfort strip 14 is attached to the cartridge 10 and extends approximately parallel to the blades 11, 12. The comfort strip 14, in general, is impregnated with a lubricious material or other shaving aid to improve the comfort of a shaving operation.

Capacitance sensors 15, 16 are formed by two approximately parallel electrically conductive portions of blades 11, 12, and sense changes in capacitance between the blades. As the blades 11, 12 or the razor cartridge 10 are displaced relative to each other, the distance between the two conducting sensors 15, 16 varies in inverse proportion to the capacitance therebetween. These changes in capacitance are detected by a receptor located in a body portion of the razor (not shown) via a wire 18, which receives electrical signals from the sensors 15, 16 and then transmits the signals through the razor head to the receptor. Though a wire 18 is shown in this embodiment, other types of electrical connections may also be used, e.g., printed circuit boards and/or connectors.

The capacitance sensors 15, 16 are disposed in a position to detect the result of the forces encountered during shaving and to provide an electrical signal indicative of those forces. Among the various forces which normally will be encountered are those which flex the cartridge 10 upward or downward and those which produce stress and strain on the blade or blades 11,12. Though this embodiment shows the sensor to be a capacitive sensor, other types of sensors may also be used, such as hall effect sensors or charge transfer type sensors.

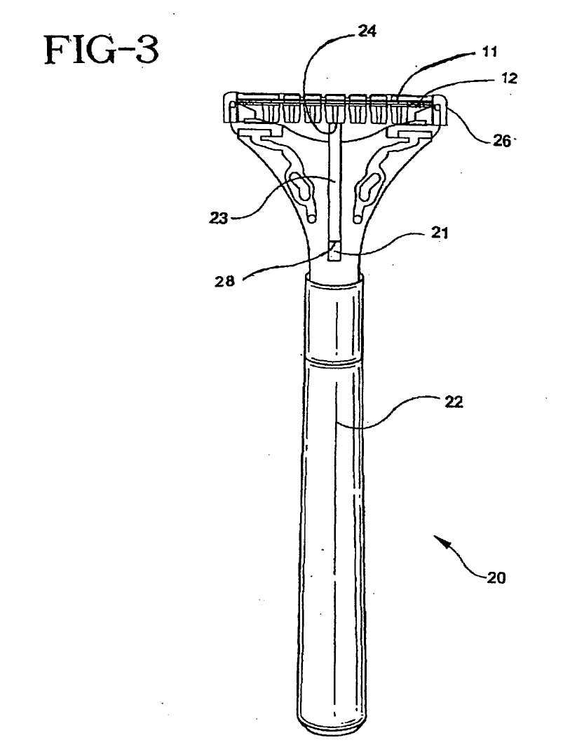

Referring to FIG. 3, a razor system 20 is shown having a sensor 21 positioned within a razor handle 22. In this embodiment, the sensor 21 indirectly measures externally applied forces on the blades 11, 12 which are transferred to the handle 22. The sensor 21 is non-piezoelectric and may be any one or combination of an electromagnetic induction sensor, an ultrasonic sensor, a hall effect sensor, a capacitive sensor, a charge transfer sensor, an electric field sensor, a photoelectric sensor, a magnetostrictive sensor or an angular rate sensor. A moveable piston 23 is coupled for movement to the handle 22. An end 24 of the piston 23 engages the razor cartridge 26 while a generally opposite end 28 slidable cooperates with the razor handle 22 and is in operative communication with the sensor 21.

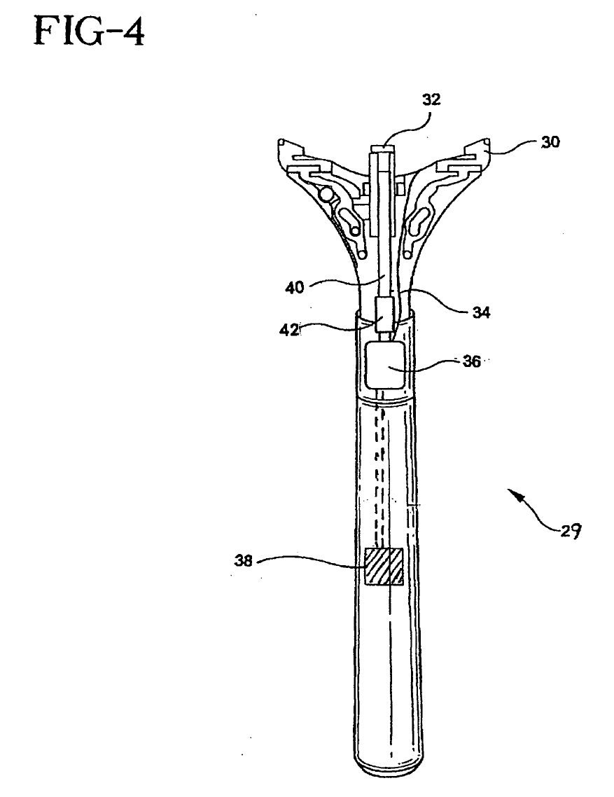

As shown in FIG. 4, a razor handle, generally designated by the reference numeral 29, includes a sensor mounted in a razor cartridge 44. The handle 29, includes a cartridge retainer 30 adapted to retain the cartridge retainer on the handle. A piston 32 is coupled to the handle 29 and includes an end 33 positioned between two retaining ends 35 defined by the cartridge retainer 30. A conductor 34 and a receptor are illustrated in FIG. 4 in the form of an electric motor 36 and signal processing circuit 38 are all disposed in the handle. Upon attachment of a razor cartridge to the handle 29, either permanently or replaceably, conductor 34 is connected to the sensor forming part of the razor cartridge 30 to form a circuit and receive the sensor signal through the conductor 34.

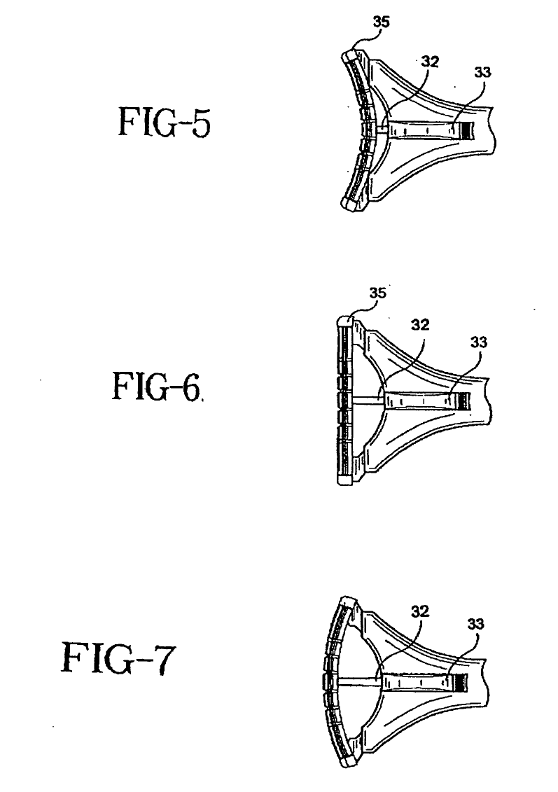

Two different types of receptors for receiving and processing the sensor signal exist which may be employed in each preferred embodiment of the invention. The first receptor embodiment is active and in the form of a signal processing circuit which processes the sensor signal and produces a response to move and position the blades. In the embodiment illustrated in FIG. 4, the receptor is a signal processing circuit 38 in conjunction with an actuator, which is used to move and position the piston 32. While the actuator may be any actuator suitable for sufficiently moving the piston 32, such as a lead screw 40 driven by the electric motor 36 in series with coupling device 42. The piston 32 or a portion of the piston is threaded and rides along the lead screw 40 as the motor 36 responds to the feedback signal generated by the signal processing circuit 38 in response to signals received from the sensor. The conductor 34 transmits the electrical signal from the sensor in the razor cartridge 44 to the signal processing circuit 38 to complete the electrical circuit. Based on the motor's 36 response to the sensor signal, the lead screw 40 rotates and piston 32 correspondingly extends and retracts as necessary to flex the razor head 44 to position the razor head to produce a consistent shave. As illustrated in FIGS. 5, 6 and 7, the expansion of the piston 32 will flex the razor head 44 into a convex shape while the retraction of the piston 32 will flex the razor head 44 into a concave shape.

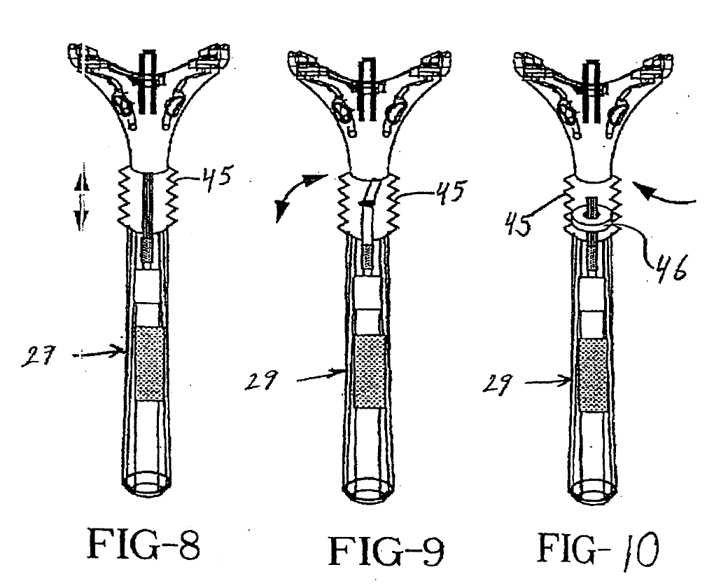

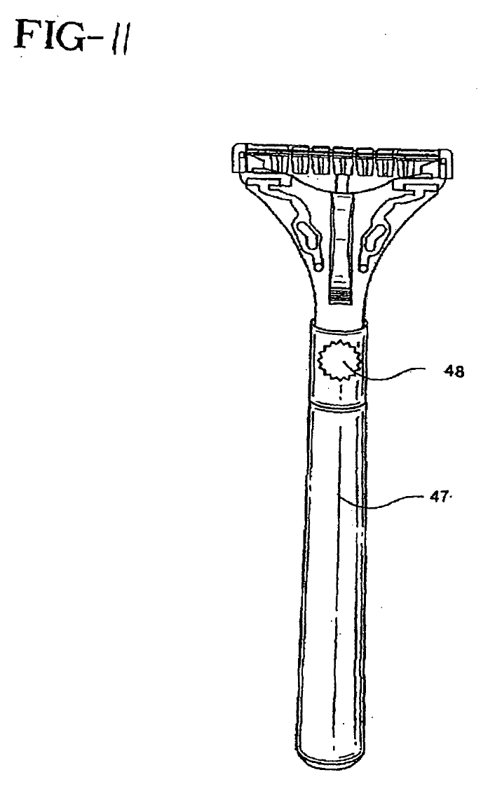

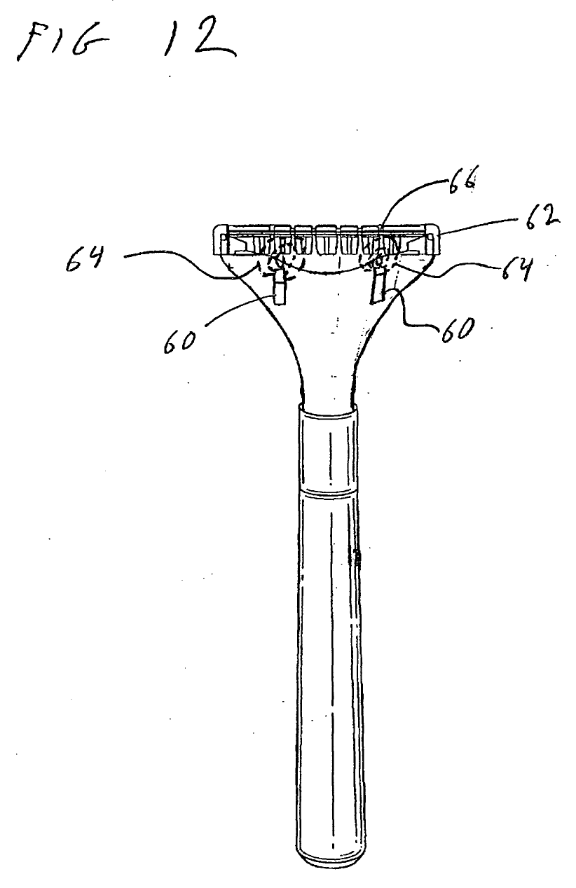

Alternatively, as illustrated in FIGS. 8, 9 and 10 respectively, the handle 29 may include a flexible section 45 which may be used in conjunction with an active receptor system to extend, bend or rotate the handle 29 rather than the razor head 44. As will be described in greater detail hereinafter, an angular rate sensor 46 can be utilized to measure the yaw, pitch and roll of the blades as the flexible section is made to move.

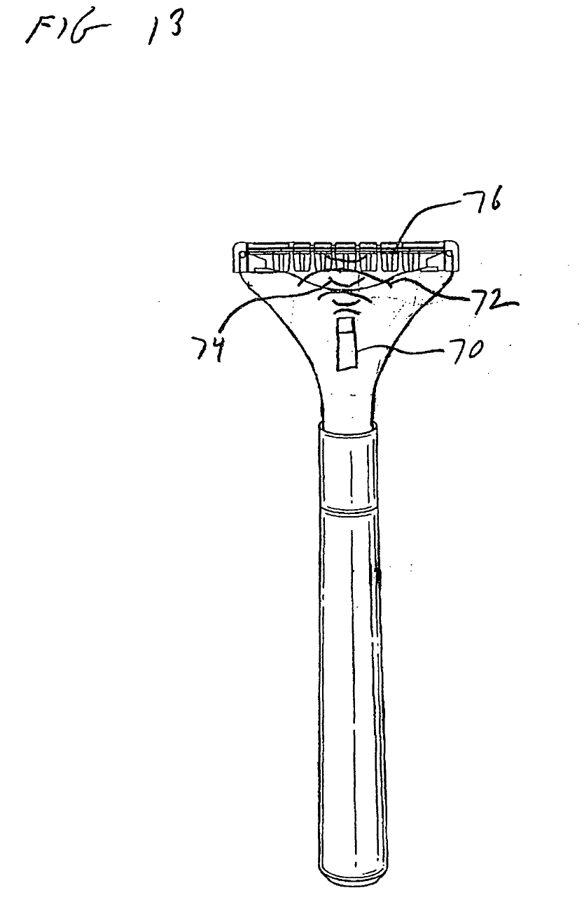

As shown in FIG. 11, the receptor can also take the form of a passive system. In this embodiment one or more sensors may be located in the razor head, and the handle may be configured as in the above-described embodiment. In the present embodiment, the receptor in the handle 47 does not produce motion but instead is a signal processing circuit which activates an indicator, such as a light 48. The receptor in the passive system may also activate a light emitting diode (LED) or any other desired indicator. The signal processing circuit receives the electrical signal from the sensors and activates an indicator, such as a light, which provides the user with a visual signal that he or she should take some action. For example, the sensor may be used to differentiate that the user is exerting too much or too little pressure during shaving by generating a comparable electrical signal that would produce a visual indication to the user to change the shaving pressure. In addition, because blades dull over time and thus require more pressure to cut hair, the application of additional shaving pressure may be used to indicate that either the disposable razor should be discarded or, in a permanent system, that the razor cartridge should be replaced. In an alternative embodiment, a voltage may be used to activate a device such as a motor or piezoelectric transducer to produce a motion, such as a vibration, or to activate an electric circuit on a circuit board or solid state chip which produces an audible sound, such as notes of a song and/or a human-like voice. In a further alternative embodiment, the passive system may be combined with the active system. For example, the receptor may activate an actuator to produce a constant shave pressure while at the same time lighting an indicator to indicate that the blades are worn and need replacing.

Different sensor types can be used in the above described razor system, some of which will now be described in detail.

Electromagnetic Induction Sensors:

According to one embodiment of the present invention, one or more electromagnetic induction sensors can be utilized either in the razor head or the razor handle. As used herein, the term “electromagnetic induction sensors” include variable impedance, variable reluctance, inductive, and eddy current sensors. Sensors detecting changes in impedance, reluctance, and induction of a sensor coil are used in industrial applications and generally comprise a coiled conductive wire. When a time-varying current is passed through the coil, a magnetic field is generated. The impedance of the sensor coil varies as a function of distance between a conductive target and the sensor coil. If ferromagnetic targets are introduced into the magnetic field, the inductance increases. When low oscillation frequencies are used to induce the magnetic fields, variable reluctance is very sensitive to the target to coil distances. The changes in impedance, reluctance, and induction are directly related to changes in distance between the target and the sensor coil.

Eddy currents are electric currents inducted in a conductor when it is introduced into a magnetic field. The secondary magnetic field generated for the non-magnetic conduction can decrease the effective impedance which is exploited to sense position.

The eddy current sensor consists of a coiled wire. High oscillation frequencies are used to induce the magnetic field and impose eddy currents on the target conductive material. The impedance coupling between the electromagnetic field in the sensor coil and the target material varies as a function of the distance between the sensor coil and the conductive material. This impedance change is calibrated over the displacement range. The measuring range is directly proportional to the sensor diameter. Best performance is achieved for distances 10% of the sensor diameter but can be measured as high as 50% of the sensor diameter with some loss in sensitivity.

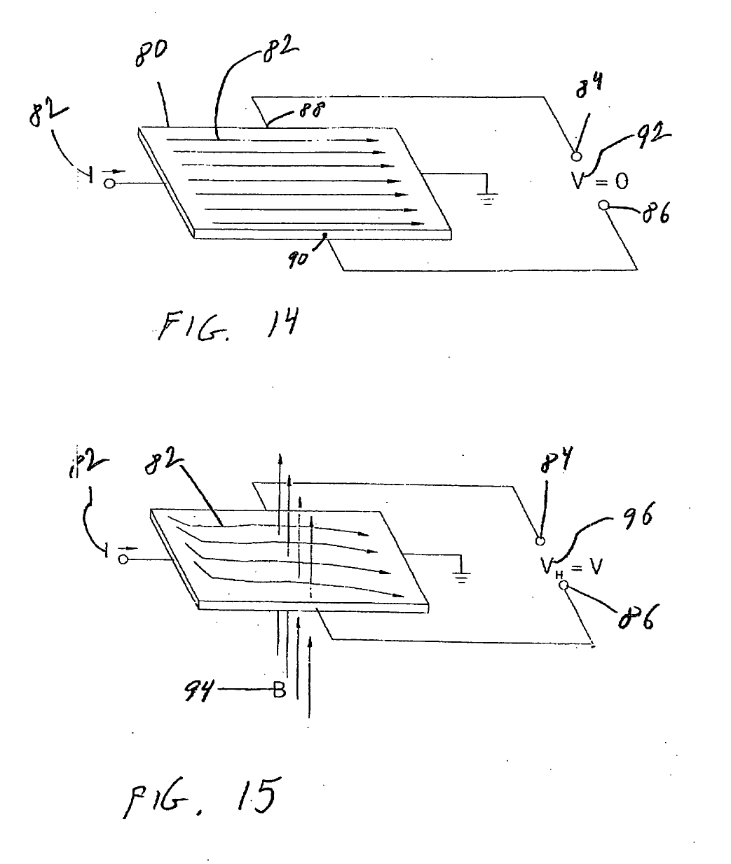

Referring to FIG. 12, in an exemplary embodiment of the present invention, electromagnetic induction sensors 60 are placed within the razor handle behind the razor cartridge 62. A magnetic field 64 is generated and is sensitive to the proximate distance of the stainless steel blades 66. The blades 66 can be used as the target material or a conductive material can be incorporated, deposited, or applied to the razor head or blades to induce a signal.

Dynamic displacement measurements using electromagnetic induction sensors can be utilized independently or coupled with an active or passive feedback mechanism to improve and enhance the shaving process. Displacement measurements can be used to actively control cartridge and/or blade position as well as razor head position. In a passive mode, a discernible signal can be used to indicate the need for razor head replacement and for the need for razor head repositioning.

Ultrasonic Sensors:

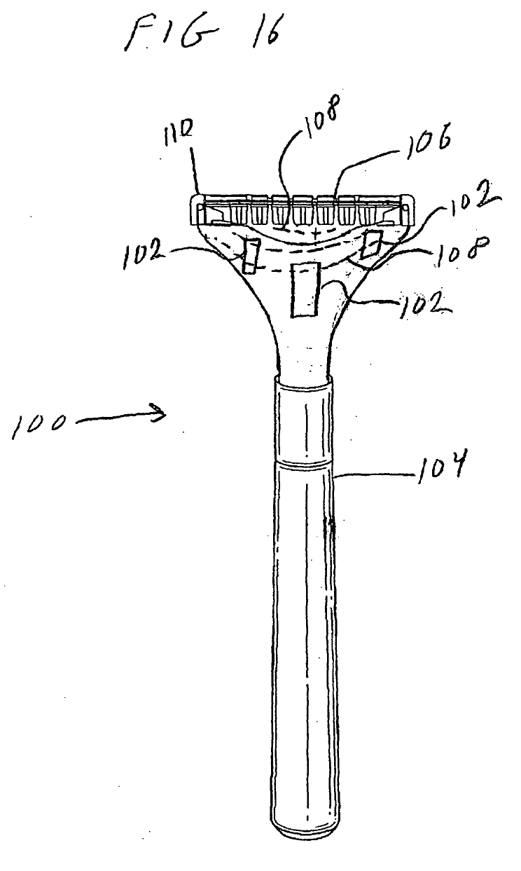

Referring to FIG. 13, in another embodiment of the present invention, one or more ultrasonic sensors 70 are utilized. Ultrasonic waves 72 are sound waves at frequencies above the audible range. The transmission of ultrasonic waves and the monitoring of the reflected waves 74 are commonly used to image, detect and measure. Ultrasonic transducers 70 are generally manufactured from piezoelectric and magnetostrictive materials. Ultrasonic transducers resonate at ultrasonic frequencies and transmit sound waves 72 to an object such as blades 76. Object distances can be determined by the time interval between the transmitted 72 and reflected 74 ultrasonic signal. This signal is very sensitive and easily measures moving objects even over large distances. Material density can also be identified by monitoring the reflections of short transmission or bursts of ultrasonic waves for a non-moving object. Ultrasonic sensors are unaffected by dust, dirt or high moisture environments.

According to the various aspects of the present invention, the ultrasonic sensor can be used in at least two ways. It can be placed in the handle to monitor movement of one or more skin engaging elements, e.g. razor blades, to monitor movement of an entire razor head, to provide signal to an active feedback system to adjust the razor cartridge, blade or razor head. The ultrasonic sensor can additionally or alternatively be placed in the handle or on one or more skin engaging elements such as the blades to monitor the features of the area to be shaved. Density measurements of the area to be shaved can be used to adjust the razor cartridge, blade or head to enhance the shave quality. In a passive mode, the signal could be used to indicate the need for blade or razor head replacement and/or the need for razor head repositioning.

Hall Effect Sensors:

Another embodiment of the present invention utilizes one or more Hall effect sensors. The Hall effect involves the development of an electric potential gradient in a current carrying conductor when placed in a magnetic field such that the direction of the magnetic field is perpendicular to the current flow.

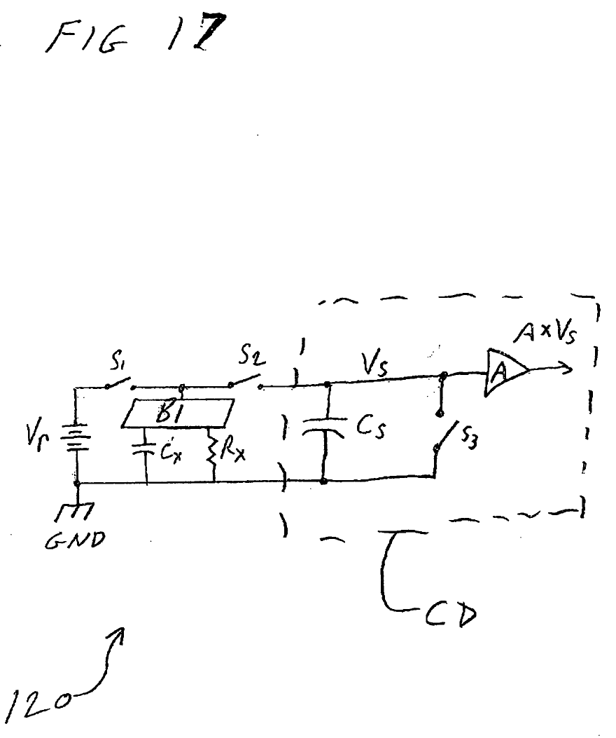

FIGS. 14 and 15, illustrate the basic principle of the Hall effect. FIG. 14 shows a thin sheet 80 of semiconductor material (the Hall element) through which a current I (ref. no. 82) is passed. The output terminals 84 and 86 are connected to opposing sides of the Hall element 80 at attachment points 88 and 90 such that the terminals are oriented perpendicular to the direction of current flow. When no magnetic field is present, current distribution is uniform and no potential difference V (designated by ref. no. 92) is seen across the output terminals 84 and 86.

Referring to FIG. 15, when a perpendicular magnetic field B (ref. no. 94) is present, a Lorentz force is exerted on the current. The force disturbs the current 82 distribution, resulting in a potential difference Vh (ref. no. %) across the output terminals 84 and 86. This voltage Vh is called the Hall voltage. The Hall voltage % is proportional to the vector cross product of the current I and the magnetic field B.

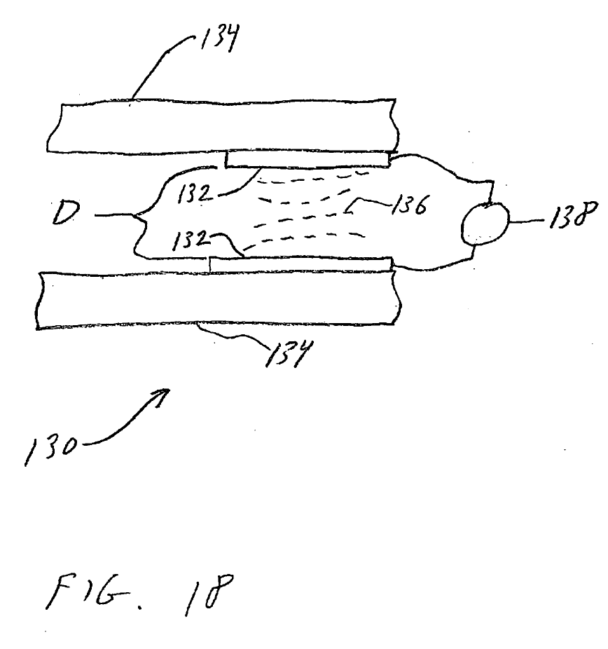

Referring to FIG. 16, an exemplary embodiment of a razor system 100 is shown having one or more hall effect sensors 102 disposed in the upper portion of the handle 104. In this embodiment at least a portion of blades 106 are magnetized to produce a magnetic field 108. The hall sensors 102 are oriented such that the magnetic field 108 from the blades 106 is perpendicular to the flow of current through the hall elements of the sensors.

The hall effect sensors 102 have one or more hall elements and proper signal conditioning incorporated therein. They are linear with flux but not with distance. However, these sensors are very repeatable and can be calibrated for the desired range.

The magnetic field 108 can alternatively be generated by the implementation of a magnet within the razor handle 104, the razor cartridge 110 or the blades 106 themselves such that the magnetic field is detectable by a current carrying object, i.e. a hall element. The hall element can alternatively be a conductive wire, plate or film on the razor handle, razor head, the razor blades or some other skin engaging element. The razor blades themselves can also be the hall element.

Dynamic displacement measurements using Hall effect sensors can be coupled with an active or passive feedback mechanism to improve and enhance the shaving process. Displacement measurements can be used to actively control razor cartridge and blade position as well as razor head position. In a passive mode, one or more signals can be used to indicate the need for cartridge replacement and/or the need for razor head repositioning.

Capacitive Sensors:

Referring back to FIGS. 1 and 2, according to a still further embodiment of the present invention, one or more capacitance sensors 15, 16 are utilized. Capacitance sensors sense a change in capacitance. A capacitor consists of two parallel plates separated by a dielectric or insulating material (in this case, air). The sensor can be one conductive surface 15 and the target is the other conductive surface 16 with the material in-between as the dielectric or insulating material. The capacitance is directly proportional to the dielectric constant of the material between the conducting plates and the common area between the plates, and is inversely proportional to the distance between the plates. This relationship enables one to monitor the change in capacitance as a function of distance between the sensor and the target to obtain displacement measurements. One could also obtain information on the change in dielectric constant between the plates when the distance between the plates is constant and the environment between the plates changes.

Thus, this aspect of the present invention comprises a razor system where a conductive surface is placed anywhere on the razor head, or cartridge to serve as the sensor and another conductive surface, the target, is placed in the razor head or cartridge such that the sensor and the target conductive surfaces are parallel. The target or sensor conductive surface could consist of the blades or blade material. The conductive surfaces can be applied, coated or inserted anywhere in the razor system. The sensor and the target must be applied in such a format that the distance between the two conductors varies as the blades or the razor cartridge are displaced. Dynamic displacement measurements using capacitive sensors can be coupled to active or passive feedback mechanisms to improve and enhance the shaving process. Displacement measurements can be used to actively control razor cartridge and blade position as well as razor head position. In a passive mode, one or more signals can be used to indicate the need for cartridge replacement and/or the need for razor head repositioning. This sensor could also be used within the razor system to monitor the humidity level and the environmental conditions that the blade sees in its shaving environment and/or to determine blade life in such an environment.

Charge Transfer Sensors:

FIG. 17 illustrates an exemplary embodiment of a charge transfer sensor 120 that may also be used in a razor system of the present invention. A conductive object, such as a blade B1 of a razor system, will have a capacitance Cx that will vary depending on such conditions as wetness or proximity to a hirsute surface. The charged blade B1 will transfer a portion of its charge when connected to another capacitor Cs without a net loss in charge. When the capacitance of one capacitor Cs is much greater than the other Cx, nearly all the charge is transferred to the larger capacitor and results in a voltage Vs on that capacitor which is directly proportional to that charge. The resulting voltage Vs occurring during the transfer of charge from a unknown Cx to a known capacitor Cs using a reference voltage Vr can be used to calculate the unknown capacitor value Cx.

One form of charge transfer sensor used for ground-reference or open electrode sensing involves rapid charge and discharge of the sense element with respect to an earth return GND. An electrode element such as blade B1 having a capacitance Cx is first connected to a voltage reference Vr via a switch S1. Then S1 is reopened after Cx is satisfactorily charged to the potential of the reference voltage Vr. Then, after as brief as possible a delay so as to minimize leakage effects caused by conductance Rx, switch S2 is reopened. The charge is then read out of the charge detector CD and used. The charge detector CD can simply be a much larger capacitor Cs than the expected value of Cx connected to an amplifier A to buffer and amplify the resulting voltage Vs. The conditions can then be discharged and reset with a switch S3 for the next measurement.

A sensor like the one developed by Quantum Research Group, QPROX□ uses this principle of charge transference and has implemented this concept to involve proximity detection, position sensing, material analysis and other features which can be exploited to enhance wet razor systems.

Water, because of its inherent conductivity, conducts the sensing current thus increasing the capacitive load in an inconsistent manner. Such random acts can not be modeled and make charge transfer sensors difficult to use in wet environments. However, the QPROX□ sensor uses short pulses to suppress the effects of water and moisture. The QPROX□ sensor can also take advantage of the frequency sensitivity of this sensor with water and vary the frequency while monitoring the response to determine moisture level and content.

Such a charge transfer device can be used in a razor system to determine if the shaver's skin is properly hydrated for shaving and either warn the user of their skin condition or activate a device which would hydrate the skin. The charge transfer sensor can be used to determine dynamic displacement measurements to monitor blade and cartridge position. These measurements can be coupled with active or passive feedback mechanisms to improve and enhance the shaving process. Displacement measurements can be used to actively control razor cartridge and blade position, as well as razor head position. In a passive mode, one or more signals can be used to indicate the need for cartridge replacement and/or the need for razor head repositioning.

Additionally and/or alternatively, material analysis can be performed on the blade over time to determine blade condition and wear. Such information could be used to indicate to the user when the blade should be replaced as well as update the user on the condition of the blade over time. A charge transfer sensor can also be used to count the number of strokes a shaver performs per shave to be used to indicate when a blade should be replaced. Such information can be used to understand the shaving patterns of an individual shaver which could be used to teach the razor about its user's shaving habits and trends. The charge transfer signal can also be used to turn the razor system on in the presence of its user.

Electric Field Sensors:

According to a still further embodiment of the present invention, one or more electric field sensors are utilized either alone or in combination with other types of sensors. Electric field sensors consist of two electrodes or antennae that are generally powered by less than 1 milliwatt. Changes in the field strength can be detected as an object moves toward or away from the electrodes which are stationary, or as the electrodes move closer or farther apart from one another. These changes can indicate dynamic displacement information.

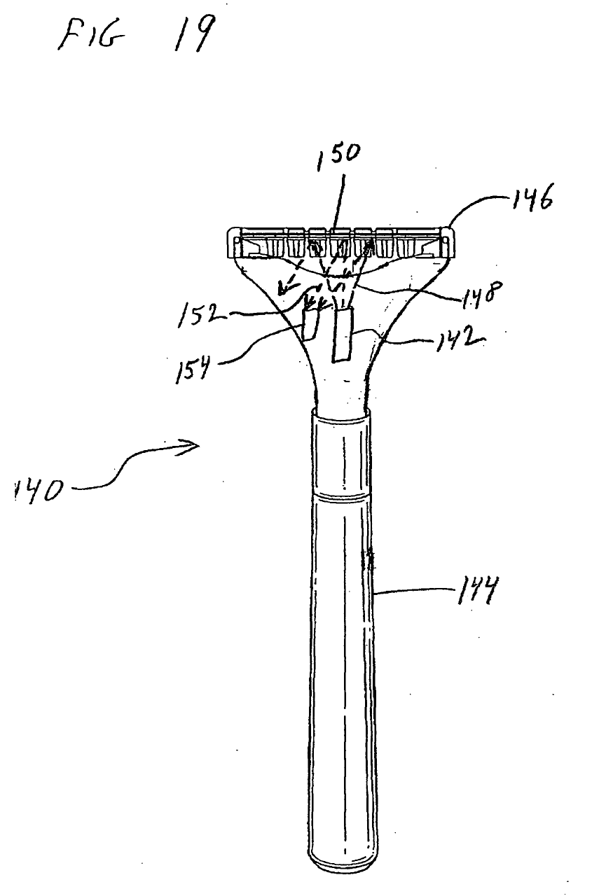

Referring to FIG. 18, an exemplary embodiment of an electric field sensor 130 for a razor system includes a pair of conductive coatings 132 disposed on each of a pair of parallel blades 134. The coatings 132 serve as the electrodes or antennae of the electric field sensor 130. An electric field 136 is generated when the antennae 132 are powered by a one milliwatt power supply 138 appropriately placed within the razor system. As the blades 134 are displaced during shaving, the distance D between the blades changes and proportionally so does the electric field 136.

Antennae may consist of any conductive surface can be placed anywhere within the razor system. Conductive surfaces can be placed anywhere on the razor head or cartridge; however, the two antennae must be near each other. The blades or blade material can be used as an antenna, or conductive surfaces may be applied, coated or inserted anywhere in the razor system. The antennae must be applied in such a way that the distance between the two conductors varies as the blades or the razor cartridge are displaced.

Dynamic displacement measurements can be coupled with an active or passive feedback mechanism to improve and enhance the shaving process. Displacement measurements can be used to actively control razor cartridge and blade position as well as razor head position. In a passive mode, one or more signals can be used to indicate the need for cartridge replacement and/or the need for razor head repositioning.

Photoelectric Sensors:

An alternative embodiment of the present invention utilizes one or more photoelectric sensors either alone or in combination with other sensors. Photoelectric sensors use light to sense. Any wavelength of light may be used but current detector technology tends to limit most photoelectric detectors to the visible and infrared regions of the spectrum. A photoelectric sensor consists of a light source and a light sensitive device, the detector. Light emitting diodes (LEDs) are often used in these sensors as the light source. Visible and infrared LEDs are available. Visible LEDs are particularly useful for sensing color differences while infrared LEDs are useful for security. Other light sources include visible and infrared semiconductor lasers. The detector can consist of a photocell, a phototransistor or other light detector.

There are several ways to use light to detect and measure deflections and distances. With a coherent light source such as a laser [and/or], a moving mirror Michelson interferometer can be implemented to measure the distances of a deflecting blade. In this set up either the blade or a reflective coating applied to the back of the blade or cartridge could be used as the moving mirror. As the mirror moves, the optical pathlength changes. A change in the optical pathlength is directly proportional to the wavelength of the coherent light and the number of constructive interference fringes. The number of fringes produced as the mirror moves provides a measure of the change in distance. The light source and the interferometer components would reside in the razor head and handle and exit the razor head behind the cartridge through an optical window or fiber. For this sensor to work properly, the detection area must be free of light reflecting contaminants. Special coatings can be applied to the lenses and reflecting surface of the blades or cartridge to minimize light intensity losses. Another configuration consists of attaching a piston to the cartridge or blades with a reflective end. This piston is then guided into the razor head. In this configuration, the interferometer components and the moving mirror inside the razor head are out of the contaminating environment.

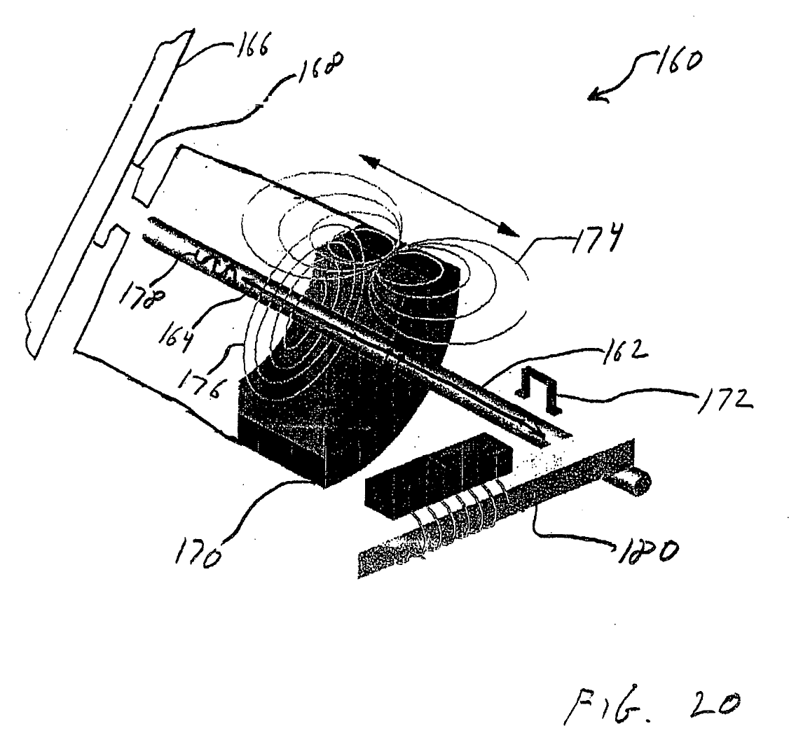

Referring to FIG. 19, another method of implementing a photoelectric sensor is to monitor the intensity of the reflected light as shown in the razor system 140. The amount of light detected from reflections from a target, a reflective surface, is dependent on the distance between the target and the light source. A calibration curve associated with the detection intensity as a function of distance can be used to provide a relative distance measurement. In this configuration, a light source emitter 142 is placed in the razor system 140 within the handle 144 just behind the razor cartridge 146. The emitter in this case is an LED, but other light sources, such as lasers, may also be used.

Light 148 from the emitter is emitted and reflected from a target object, i.e. blades 150. The reflected light 152 is detected by the detector 154 located adjacent to the emitter 142. The light source can be modulated to a high frequency and the detector is tuned to that frequency thereby rejecting ambient light. A reflective surface or coating can be applied to the back of the cartridge or the blades can be used directly or be coated to reflect the light into the detector. As the cartridge or the blades move, the amount of detected light changes accordingly. This type of photoelectric sensor is also sensitive to light reflecting contaminants. Special coatings can be applied to the lenses and reflecting surface of the blades or cartridge to minimize light intensity losses. A configuration consisting of a piston in contact with the cartridge or blades with a reflective end could be implemented. In this configuration, the piston is guided into the razor head and the optical components are out of the contaminating environment.

A third photoelectric application incorporates triangulation methods wherein a beam of light is reflected at an angle from the surface and detected at some other angle. As the blade or cartridge moves, the deflected beam displaces correspondingly onto the detector. This type of photoelectric sensor is also sensitive to light reflecting contaminants. Special coatings can be applied to the lenses and reflecting surfaces of the blades or cartridge to minimize light intensity losses. A configuration consisting of a piston in contact with the cartridge or blades with a reflective end could be implemented. In this configuration, the piston is guided into the razor head and the optical components are out of the contaminating environment.

Photoelectric proximity switches could also be used where one or more light emitting diodes and detector pairs are arranged parallel to the blade. These proximity switches are placed within the razor head such that the spacing between the emitter and detector pairs is known. As the blade deflects, it blocks the beam and thus indicates a blade position by the number of switches opened and closed. This arrangement is also amenable to a piston configuration, where the piston blocks the light beam as the blade or razor head is deflected.

Two pairs of emitter and detector inputs can be used in a quadrature decoder. A piston arrangement would be used. One end of the piston would be in contact with the blades or cartridge while the other end would be guided within the razor head. The end of the piston guided within the razor head would be patterned with optically opaque and transparent regions. The spacing of this pattern would coincide with the spacing of the emitter and detector pairs such that when the pattern runs between the emitter and detector pairs, one switch is open while the other is dosed. In this configurations, piston direction, speed and distance can be determined by the state of two optical switches.

All of these displacement measurements systems can be coupled with an active or passive feedback mechanism to improve and enhance the shaving process. Displacement measurements can be used to actively control razor cartridge and blade position as well as razor head position. In a passive mode, one or more signals can be used to indicate the need for cartridge replacement and/or the need for razor head repositioning.

Magentostrictive Sensors:

A still further embodiment of the present invention comprises the use of one or more magnetostrictive sensors used either alone or in combination with another type of sensor. In the presence of a magnetic field, ferroelectric materials can deform laterally as well as longitudinally. This characteristic can be exploited in a sensor configuration wherein a magnetostrictive waveguide consisting of a tube made of magnetostrictive material is used. Within the waveguide, a conductive element such as a copper wire is positioned to transmit a current pulse through the waveguide. A moveable magnet which can be placed anywhere along the waveguide is used to indicate distance. The introduction of a magnetic field around the waveguide produces an acoustic pulse that travels within the waveguide and is detected. The time interval between the sent current pulse and the received acoustic pulse is proportional to the distance between the magnet position and the receiver.

A magnetostrictive sensor assembly 160 for a razor system is illustrated in FIG. 20. According to this aspect of the present invention, a small tubular magnetostrictive waveguide 162 with a wire 164 concentrically placed within the tube is placed perpendicular to a blade 166 within the razor system. A piston 168 which is in contact with the razor cartridge or blades 166 glides around the waveguide 162. At the end of the piston 168 is a magnet 170 that moves along the waveguide 162 as the piston 168 is displaced during the shaving process. Current pulses 172 at regular intervals are sent through the conductor 164. The magnet 170 generates a moveable magnetic field 174 which passes along the outside of the waveguide 162. The current pulses 172 also generate a magnetic field 176, which propagates radially from the center of the waveguide and approximately perpendicular to the magnetic field 174 generated from the magnet 170. The interaction of the two magnetic fields 174 and 176 minutely deform the waveguide to produce a strain pulse, which travels at sonic speed as an acoustic wave pulse 178 until the acoustic pulse is detected and converted to an electronic signal by wave converter assembly 180. The position of the magnet 170, and thus the amount of deflection of the blade 166 is determined with high precision by measuring the elapsed time between the launching of the current pulse 172 and the detection of the acoustic wave pulse 178. This type of sensor is very robust and is impervious to dirt, debris and water environments.

Dynamic displacement measurements can be coupled with an active or passive feedback mechanism to improve and enhance the shaving process. Displacement measurements can be used to actively control razor cartridge and blade position as well as razor head position. In a passive mode, one or more signals can be used to indicate the need for cartridge replacement and/or the need for razor head repositioning.

Angular Rate Sensors:

Referring back to FIG. 10, a still further embodiment of the present invention utilize an angular rate sensors 46 which can sense yaw, pitch or roll. Each sensor can detect a single axis angular rate. Silicon micromachined angular rate sensors are becoming more widespread because of their extreme promise as sensors for the automobile industry to aid in four-wheel steering, automatic braking, skid detection and collision avoidance. These sensors actively sense inertial movements.

According to this embodiment of the present invention, the angular rate sensors 46 are used to sense the inertial movements of the razor handle or head. Angular rate information can be used to adjust the head angle and tilt in such a way that the user does not have to contort their arm or wrist to shave certain hard to reach areas. This would produce an extremely ergonomic razor and would be particularly useful to woman who must contort themselves to shave behind legs and around ankles.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A razor system comprising:
a razor cartridge including at least one blade;
a handle attached to the razor cartridge; and
a non-piezoelectric sensor coupled to the razor system for generating a sensor signal indicative of parameters sensed during a shave.

2. The razor system of claim 1 wherein the sensor includes at least one of an electromagnetic induction sensor, an ultrasonic sensor, a hall effect sensor, a capacitive sensor, a charge transfer sensor, an electric field sensor, a photoelectric sensor, a magnetostrictive sensor and an angular rate sensor.

3. The razor system of claim 1 wherein at least a portion of the cartridge is movable to follow the contours of a hirsute surface during a shaving operation.

4. The razor system of claim 1 comprising a receptor electrically connected to the sensor, wherein the receptor includes a signal conditioning circuit for processing the sensor signal to generate a corresponding feedback signal.

5. The razor system of claim 4 comprising an actuator electrically connected to the signal conditioning circuit and operatively connected to the at least one razor blade, wherein the actuator moves the at least one razor blade in response to the feedback signal.

6. The razor system of claim 5 wherein the actuator is operatively connected to the razor cartridge and moves the razor cartridge in response to the feedback signal.

7. The razor system of claim 5 wherein the handle has a flexible section and the actuator is operatively connected to the flexible section of the handle for movement thereof in response to the feedback signal.

8. The razor system of claim 4 comprising an indicator electrically connected to the signal conditioning circuit, wherein the indicator is responsive to the feedback signal.

9. The razor system of claim 1 wherein the sensor is disposed in the razor cartridge.

10. The razor system of claim 1 wherein the sensor is disposed in the handle.

11. The razor system of claim 1 wherein the sensor is an electromagnetic induction sensor, which senses distance between a conductive target and the sensor.

12. The razor system of claim 11 wherein the sensor is disposed in the razor handle behind the razor cartridge and the target is the at least one blade.

13. The razor system of claim 1 wherein the sensor is an ultrasonic sensor disposed in the handle and resonates at ultrasonic frequencies to monitor movement of one or more skin engaging elements.

14. The razor system of claim 1 wherein the sensor is a hall effect sensor including:
a magnet generating a magnetic field; and
a current carrying conductor disposed in the magnetic field perpendicular to the direction of the current flow.

15. The razor system of claim 14 wherein the magnet is disposed in the razor handle and the current carrying conductor is disposed in the razor cartridge.

16. The razor system of claim 1 wherein the sensor is a capacitive sensor having a sensor plate and a target plate wherein the sensor monitors change in capacitance as a function of distance between the sensor plate and the target plate as a function of distance therebetween.

17. The razor system of claim 16 wherein the at least one blade comprises:
a first blade having the sensor plate disposed thereon; and
a second substantially parallel blade having the target plate disposed thereon.

18. The razor system of claim 1 wherein the sensor is a charge transfer sensor used to determine moisture level and content.

19. The razor system of claim 1 wherein the sensor is an electric field sensor including a pair of electrodes proximate each other, the electrodes generating an electric field therebetween such that changes in the electric field are indicative of dynamic displacement information.

20. The razor system of claim 19 wherein the distance between the electrodes vary as the at least one blade is displaced.

21. The razor system of claim 1 wherein the sensor is a photoelectric sensor having a light source and a light sensitive detector.

22. The razor system of claim 21 wherein the light source includes a laser light and the sensor is utilized to measure distances of deflection of the at least one blade.

23. The razor system of claim 1 wherein the sensor is a magnetostrictive sensor wherein current pulses are transmitted and acoustic waves are sensed to monitor displacement of the at least one blade.

24. The razor system of claim 7 wherein the sensor is an angular rate sensor utilized to measure yaw, pitch and roll of the at least one blade as the flexible section is moved.

25. A razor cartridge for attaching to a razor handle of a razor system, the razor cartridge comprising:
at least one blade; and
a sensor disposed in the razor cartridge for generating a sensor signal indicative of parameters sensed during a shave, the sensor including at least one of an electromagnetic induction sensor, an ultrasonic sensor, a hall effect sensor, a capacitive sensor, a charge transfer sensor, an electric field sensor, a photoelectric sensor, a magnetostrictive sensor and an angular rate sensor.

26. The razor cartridge of claim 25 wherein the sensor is an electromagnetic induction sensor, which senses distance between a conductive target and the sensor.

27. The razor cartridge of claim 25 wherein the sensor is an ultrasonic sensor and resonates at ultrasonic frequencies to monitor movement of one or more skin engaging elements.

28. The razor cartridge of claim 25 wherein the sensor is a hall effect sensor including:
a magnet generating a magnetic field; and
a current carrying conductor disposed in the magnetic field perpendicular to the direction of the current flow.

29. The razor cartridge of claim 25 wherein the sensor is a capacitive sensor having a sensor plate and a target plate wherein the sensor monitors change in capacitance as a function of distance between the sensor plate and the target plate as a function of distance therebetween.

30. The razor cartridge of claim 29 wherein the at least one blade comprises:
a first blade having the sensor plate disposed thereon; and
a second substantially parallel blade having the target plate disposed thereon.

31. The razor cartridge of claim 25 wherein the sensor is a charge transfer sensor used to determine moisture level and content.

32. The razor cartridge of claim 25 wherein the sensor is an electric field sensor including a pair of electrodes proximate each other, the electrodes generating an electric field therebetween such that changes in the electric field are indicative of dynamic displacement information.

33. The razor cartridge of claim 32 wherein the distance between the electrodes vary as the at least one blade is displaced.

34. The razor cartridge of claim 25 wherein the sensor is a photoelectric sensor having a light source and a light sensitive detector.

35. The razor cartridge of claim 25 wherein the sensor is a magnetostrictive sensor wherein current pulses are transmitted and acoustic waves are sensed to monitor displacement of the at least one blade.

36. The razor cartridge of claim 25 wherein the sensor is an angular rate sensor utilized to measure yaw, pitch and roll of the at least one blade.

37. A razor handle having a receptor for receiving a sensor signal indicative of parameters sensed during a shave generated from at least one of an electromagnetic induction sensor, an ultrasonic sensor, a hall effect sensor, a capacitive sensor, a charge transfer sensor, an electric field sensor, a photoelectric sensor, a magnetostrictive sensor and an angular rate sensor, the razor handle comprising a signal conditioning circuit for processing the sensor signal to generate a feedback signal.

38. The razor handle of claim 37 comprising an actuator electrically connected to the signal conditioning circuit, wherein the actuator moves in response to the feedback signal.

39. The razor handle of claim 38 wherein the actuator is operatively connected to a flexible section of the handle and moves the flexible section in response to the feedback signal.

40. The razor handle of claim 37 comprising an indicator electrically connected to the signal conditioning circuit, wherein the indicator provides an indication in response to the feedback signal.

41. The razor handle of claim 37 wherein the sensor is disposed in the handle.
